(19) United States
(12) Patent Application Publication
(10) Pub. No.: US 2002/0114751 A1
(43) Pub. Date: Aug. 22, 2002

(54) Use of a catalyst for reducing the quantity and/or size of particulates in diesel exhaust

(76) Inventors: Lothar Puppe, Burscheid (DE); Axel Konig, Wolfsburg (DE); Ulrich-Dieter Standt, Meine (DE)

Correspondence Address: William C. Gerstenzang, Norris McLaughlin & Marcus, P.A., 30th Fllor, 220 East 42nd Street, New York, NY, 10017, US

(21) Appl. No.: 09/967,452

(22) Filed: Sep. 28, 2001

Related U.S. Application Data
(63) Continuation of application No. 09/549,829, filed on Apr. 14, 2000, now abandoned.

(30) Foreign Application Priority Data
Aug. 7, 1992 (DE) P 42 26 112.0

(51) Int. Cl. B01J 8/02

(52) U.S. Cl. 423/213.2

(57) ABSTRACT

In the reduction of at least one of the quantity and size of particulates in the exhaust of a diesel engine, wherein said exhaust is contacted with a catalyst, the improvement wherein the catalyst comprises a combination of a zeolite having acidic properties and at least one oxide of a transition metal or rare earth. SO₂ in the exhaust gas is not oxidized to sulfates.

This invention relates to the use of a catalyst for reducing the quantity and/or size of particulates in the exhaust gas of a diesel engine by means of a bifunctional catalyst containing a transition metal oxide and an acidic zeolite.

One of the problems of using diesel engines, more particularly to drive motor vehicles, is that they emit particulates which are difficult to prevent from entering the atmosphere.

A well-known measure widely used to prevent particulate emissions is to use filters. The disadvantage of filters lies in the danger of blockage by the particulates after a relatively short operating time. Accordingly, measures have to be taken to regenerate the particulate filters, for example by brief heating of the filters by suitable devices to the ignition temperature of the deposited particulates. Devices such as these are complicated and expensive and are not a practical solution, for example, for diesel-powered automobiles.

It is also known that the quantity of particulates can be catalytically reduced. Oxidation catalysts containing platinum as active component on aluminium oxide are used for this purpose. The disadvantage of monofunctional noble metal catalysts of this type is that, although they reduce the quantity of particulates in the exhaust gas, they also have a strong oxidizing effect on the SO₂ component of the exhaust gases. The resulting formation of sulfate makes the particulates hygroscopic and, under certain conditions, even leads to an increase in the quantity of particulates. In addition, sulfate particles are deposited on the catalyst, reducing its effectiveness.

It is known from a hitherto patent application (P 41 05 534) that the quantity of particulates can be reduced without additional sulfate formation. It was found that zeolite-containing catalysts with acidic or cracking properties reduce the quantity and/or size of particulates and the quantity of hydrocarbons without at the same time oxidizing the SO₂ in the exhaust gas to sulfates. The disadvantage is that small quantities of particulates are still formed, above all at temperatures ≦200° C.

Accordingly, the problem addressed by the present invention was further to reduce the quantity and/or size of the particulates.

It has now been found that zeolite-containing catalysts which have acidic or cracking properties and which additionally contain oxides of the transition metals distinctly reduce the quantity and/or size of particulates in relation to the prior art without at the same time oxidizing the SO₂ in the exhaust gas to sulfates. Surprisingly, the zeolite catalysts containing the added metal oxides have no oxidizing effect on the SO₂ in the exhaust gas, even at relatively high exhaust gas temperatures.

The metal oxide addition also has a favorable effect on particulate reduction at relatively low temperatures so that particulate reduction is up to 50% greater than in the case of an acidic zeolite catalyst with no metal oxide addition.

Now, the present invention relates to the use of a catalyst for reducing the quantity and/or size of particulates in the exhaust gas of a diesel engine by means of a catalyst which is a combination of a zeolite having acidic properties and one or more transition metal oxides and/or oxides of the rare earths.

Suitable metal oxide additions are, preferably, TiO₂, V₂O₅, Cr₂O₃, MnO₂, Fe₂O₃, CoO, Nio, CuO, Y203, ZrO2, Nb₂O₅, Ta₂O₅ WO₃, MoO₃, La₂O₃, Ce₂O₃, WO₃, etc. or mixtures of these oxides.

The oxides are preferably added in quantities of 0.1 to 20% by weight and, more preferably, in quantities of 0.5 to 10% by weight.

Particularly suitable metal oxide additions are TiO₂, V₂O₅, WO₃, MoO₃, La₂O₃ and Ce₂O₃.

The metal oxides are normally added to the zeolite. In addition, a binder is added so that the mixture may be adhesively applied to a support (for example of cordierite or of metal) or press-molded to form self-supporting shaped structures. The mixture is homogenized by intensive grinding, for example in stirred ball mills. The mixtures are then dried to a moisture content suitable for granulation and are press-molded to form shaped structures in suitable units, for example roller-type granulators, extruders. As already mentioned, supports, for example in the form of shaped structures or monolithic honeycombs, may also be coated with a suspension of the active components.

The zeolite-containing catalysts may also be coated with salts of the transition metals or rare earths which may then be thermally decomposed.

Zeolites particularly suitable for use in accordance with the invention include the following structure types: faujasites, pentasils, mordenites, ZSM 12, zeolite β, zeolite L, zeolite n, PSH-3, ZSM 22, ZSM 23, ZSM 48M EU-1, NU-86, offretith, ferrierite, etc.

The pentasil type zeolite preferably has an SiO₂ to Al₂O₃ ratio of 25 to 2000:1 and, more preferably 40 to 600:1.

Zeolites are characterized by the following general formula (I):

M¹_{2/n}O.xM²₂O₃.ySiO₂.qH₂O (I)

in which

M¹ is an equivalent of an exchangeable cation, n standing for the valency and the number corresponds to the charge equalization of M²,

M² is a trivalent element which, together with the Si, forms the oxidic skeleton of the zeolite,

y/x is the SiO₂/M²₂O₃ ratio,

q is the quantity of water adsorbed.

In terms of their basic structure, zeolites are crystalline alumosilicates which are made up of a network of SiO₄ and M²O₄ tetrahedrons. The individual tetrahedrons are linked to one another by oxygen bridges over the corners of the tetrahedrons and form a three-dimensional network which is uniformly permeated by passages and voids. The individual zeolite structures differ in the arrangement and size of the passages and voids and in their composition. Exchangeable cations are incorporated to equalize the negative charge of the lattice arising out of the M² component. The adsorbed water phase qH₂O can be reversibly removed without the skeleton losing its structure.

M² is often aluminium, but may be completely or partly replaced by certain other trivalent elements.

A detailed account of zeolites can be found, for example, in D. W. Breck's book entitled “Zeolite Molecular Sieves, Structure, Chemistry and Use”, J. Wiley & Sons, New York, 1974. Another account, particularly of the zeolites relatively rich in SiO₂ which are of interest in catalytic applications, can be found in the book by P.A. Jacobs and J. A. Martens entitled “Synthesis of High-Silica Alumino-silicate Zeolites”, Studies in Surface Science and Catalysis, Vol. 33, Ed. B. Delmon and J. I. Yates, Elsevier, Amsterdam/Oxford/New York/Tokyo, 1987.

In the zeolites used in accordance with the invention, M² stands for one or more elements from the group consisting of Al, B, Ga, In, Fe, Cr, V, As and Sb and, preferably, for one or more elements from the group consisting of Al, B, Ga and Fe.

The zeolites mentioned may contain rare earths and/or protons as exchangeable cations M¹. Other suitable exchangeable cations are, for example, those of Mg, Ca, Sr, Ba, Zn, Cd and also transition metal cations such as, for example, Cr, Mn, Fe, Co, Ni, Cu, V, Nb, Mo, Ru, Rh, Pd, Ag, Ta, W, Re or Pt.

According to the invention, preferred catalysts are those which contain zeolites of the structure types mentioned above, in which at least part, preferably 50 to 100% and, more preferably, 80 to 100% of all the metal cations originally present have been replaced by hydrogen ions, and which also contain the metal oxide additions.

The acidic H⁺ forms of the zeolites are preferably produced by exchanging metal ions for ammonium ions and subsequently calcining the zeolite thus exchanged. In the case of zeolites of the faujasite type, repetition of the exchange process and subsequent calcination under defined conditions lead to so-called ultrastable zeolites relatively poor in aluminium which are made thermally and hydrothermally more stable by this dealuminization process. Another method of obtaining zeolites of the faujasite type rich in SiO₂ is to subject the anhydrous zeolite to a controlled treatment with SiCl₄ at relatively high temperatures (≧150° C.). As a result of this treatment, aluminium is removed and at the same time silicon is incorporated in the lattice. Under certain conditions, treatment with ammonium hexafluorosilicate also leads to a faujasite rich in SiO₂.

Another method of replacing/exchanging protons is to carry out the process with mineral acids in the case of zeolites which have a sufficiently high SiO₂ to Al₂O₃ ratio (>5). Dealuminized zeolites can also be obtained in this way.

It is also known that ion exchange with trivalent rare earth metal ions (individually and/or in the form of mixtures) which may preferably be rich in lanthanum or cerium, leads to acidic centers, above all in the case of faujasite. It is also known that acidic centers are formed when polyvalent metal cations are introduced into zeolites.

The following Examples illustrate the effectiveness of the acidic zeolitic or zeolite-containing catalysts additionally containing added metal oxides in particulate conversion and hydrocarbon conversion in exhaust gases of diesel engines. The Examples are not intended to limit the invention in any way.

The results were obtained from a diesel engine under the conditions shown in the Tables. The catalysts were coated monoliths 102 mm in diameter and 152 mm in length.

### EXAMPLE 1

SE zeolite Y, rare-earth-exchanged acidic zeolite Y with an SiO₂ to Al₂O₃ ratio of 4.9 and a degree of exchange of approx. 90% and containing 2% WO₃, based on the zeolite component.

| Engine | | Temp. at | HC con- | Particulate |
|---|---|---|---|---|
| speed | Pme | manifold | version | conversion |
| [r.p.m.] | [bar] | [° C.] | [%] | [%] |
| 2000 | 1 | 159 | 26.8 | 20.4 |
| 2000 | 6 | 425 | 33.4 | 34.9 |

### EXAMPLE 2

SE zeolite Y, rare-earth-exchanged acidic zeolite Y with an SiO₂ to Al₂O₃ ratio of 4.9 and a degree of exchange of approx. 90% and containing 2% MoO₃, based on the zeolite component.

| Engine | | Temp. at | HC con- | Particulate |
|---|---|---|---|---|
| speed | Pme | manifold | version | conversion |
| [r.p.m.] | [bar] | [° C.] | [%] | [%] |
| 2000 | 1 | 159 | 22.3 | 19.5 |
| 2000 | 6 | 425 | 30.6 | 36.1 |

### EXAMPLE 3

H zeolite Y, dealuminized acidic zeolite Y with a molar SiO₂ to Al₂O₃ ratio of 50 and an addition of 2% WO₃, based on the zeolite.

| Engine | | Temp. at | HC con- | Particulate |
|---|---|---|---|---|
| speed | Pme | manifold | version | conversion |
| [r.p.m.] | [bar] | [° C.] | [%] | [%] |
| 2000 | 1 | 159 | 34.3 | 26.3 |
| 2000 | 6 | 425 | 29.5 | 36.1 |

### EXAMPLE 4

H zeolite Y, dealuminized acidic zeolite Y with a molar SiO₂ to Al₂O₃ ratio of 50 and an addition of 2% MoO₃, based on the zeolite.

| Engine | | Temp. at | HC con- | Particulate |
|---|---|---|---|---|
| speed | Pme | manifold | version | conversion |
| [r.p.m.] | [bar] | [° C.] | [%] | [%] |
| 2000 | 1 | 159 | 30.9 | 21.5 |
| 2000 | 6 | 425 | 26.7 | 34.8 |

### COMPARISON EXAMPLE 5

SE zeolite Y, rare-earth-exchanged acidic zeolite Y with an SiO₂ to Al₂O₃ ratio of 4.9 and a degree of exchange of approx. 90% (no metal oxide addition).

| Engine | | Temp. at | HC con- | Particulate |
|---|---|---|---|---|
| speed | Pme | manifold | version | conversion |
| [r.p.m.] | [bar] | [° C.] | [%] | [%] |
| 2000 | 1 | 159 | 20.6 | 15.1 |
| 2000 | 6 | 425 | 27.8 | 34.0 |

1. The use of a catalyst for reducing the quantity and/or size of particulates in the exhaust of the diesel engine, characterized in that the catalyst is a combination of a zeolite having acidic properties and one or more transition metal oxides and/or oxides of the rare earths.

2. The use of a catalyst as claimed in claim 1, characterized in that the zeolite having acidic properties corresponds to the following general formula:
M¹_{2/n}O.xM²₂O₃.ySiO₂.qH₂O (I)
in which
M¹ is an equivalent of an exchangeable cation of which the number corresponds to the percentage content of M², n standing for the valency of the cation,
M² is a trivalent element which, together with the Si, forms the oxidic skeleton of the zeolite,
y/x is the SiO₂/M²₂O₃ ratio,
q is the quantity of water adsorbed.

3. The use claimed in claim or 2, characterized in that the zeolite is of the faujasite type.

4. The use claimed in claim 3, characterized in that the zeolite is a dealuminized faujasite.

5. The use claimed in claim 1 or 2, characterized in that the zeolite is of the pentasil type.

6. The use claimed in claim 5, characterized in that the pentasil type zeolite has an SiO₂ to Al₂O₃ ratio of 25 to 2000:1 and preferably 40 to 600:1.

7. The use claimed in claim 1 or 2, characterized in that the zeolite is a zeolite of the mordenite type.

8. The use claimed in claim 7, characterized in that the zeolite is a dealuminized mordenite.

9. The use claimed in one or more of claims 1 to 8, characterized in that the zeolite contains one or more elements from the group of elements of the second main group of the periodic system of elements and/or the rare earth elements as exchanged cations.

10. The use claimed in one or more of claims 1 to 8, characterized in that the zeolite contains one or more transition elements as exchanged cations.

11. The use claimed in claim 10, characterized in that the transition elements are Cu, Ni, Co, Fe, Cr, Mn and/or V.

12. The use claimed in claim 10, characterized in that the zeolite contains Cu as transition element.

13. The use claimed in claim 1, characterized in that TiO₂, V₂O₅, Cr₂O₃, MnO₂, Fe₂O₃, CoO, NiO, CuO, Y₂O₃, ZrO₂, Nb₂O₅, Ta₂O₅, WO₃, MoO₃, La₂O₃, Ce₂O₃, WO₃ or mixtures thereof are used as the transition metal oxides and/or as oxides of the rare earths.

14. The use claimed in claim 1, characterized in that the oxides are used in quantities of 0.1 to 20% by weight, based on zeolite.
